(19) United States
(12) Patent Application Publication
(10) Pub. No.: US 2009/0113863 A1
(43) Pub. Date: May 7, 2009

(54) Low Expansion Cement Compositions for Ceramic Monoliths

(76) Inventors: Yanxia Lu, Painted Post, NY (US); Isabelle Marie Melscoet-Chauvel, Bois-Le-Roi (FR)

Correspondence Address: CORNING INCORPORATED, SP-TI-3-1, CORNING, NY, 14831, US

(21) Appl. No.: 12/264,628

(22) Filed: Nov. 4, 2008

Related U.S. Application Data
(60) Provisional application No. 61/001,828, filed on Nov. 5, 2007.

(51) Int. Cl. B01D 39/06; C04B 35/04; C04B 35/64; C04B 35/14

(52) U.S. Cl. 55/523; 501/95.1; 264/630; 264/631

(57) ABSTRACT

Disclosed are cement compositions for applying to honeycomb substrates. The cement compositions contain an inorganic powder batch composition; a binder; a liquid vehicle; and an elastic modulus reducing additive. The elastic modulus reducing additive can contain a ceramic fiber or a monohydrated alumina. The cement compositions are well suited for forming ceramic diesel particulate wall flow filters. Also disclosed herein are end plugged wall flow filters that include the disclosed cement compositions and methods for the manufacture thereof.

### CROSS REFERENCE TO RELATED APPLICATION

This Application claims the benefit of U.S. Provisional Application Ser. No. 61/001,828 filed Nov. 5, 2007 and entitled “Low Elastic Modulus and Low Thermal Expansion Cement Compositions for Ceramic Honeycomb Bodies” which is incorporated by reference herein.

### FIELD

The present invention relates to the manufacture of porous ceramic particulate filters, and more particularly to improved cement compositions and processes for sealing selected channels of porous ceramic honeycombs to form wall-flow ceramic filters therefrom.

### BACKGROUND

Ceramic wall flow filters are finding widening use for the removal of particulate pollutants from diesel or other combustion engine exhaust streams. A number of different approaches for manufacturing such filters from channeled honeycomb structures formed of porous ceramics are known. The most widespread approach is to position cured plugs of sealing material at the ends of alternate channels of such structures which can block direct fluid flow through the channels and force the fluid stream through the porous channel walls of the honeycombs before exiting the filter. The particulate filters used in diesel engine applications are typically formed from inorganic material systems, chosen to provide excellent thermal shock resistance, low engine back-pressure, and acceptable durability in use. The most common filter compositions are based on silicon carbide, aluminum titanate and cordierite. Filter geometries are designed to minimize engine back-pressure and maximize filtration surface area per unit volume. Illustrative of this approach is U.S. Pat. No. 6,809,139, which describes the use of sealing materials comprising cordierite-forming (MgO—Al₂O₃—SiO₂) ceramic powder blends and thermosetting or thermoplastic binder systems to form such plugs.

Diesel particulate filters typically consist of a parallel array of channels with every other channel on each face sealed in a checkered pattern such that exhaust gases from the engine would have to pass through the walls of the channels in order to exit the filter. Filters of this configuration are typically formed by extruding a matrix that makes up the array of parallel channels and then sealing or “plugging” every other channel with a sealant in a secondary processing step. There are three general types of cement compositions in current DPF manufacturing processes: 1) a post-firing composition (also called 2-step firing composition, or second fire composition); 2) co-firing composition (also called 1-step firing composition); and 3) cold set composition (prepared at ambient temperature and mostly used for plug repairs).

The post-firing composition is used for plugging after the substrate has been fired, so the highest temperature that the composition can tolerate/withstand is about the same as the application temperature, usually less than 1100° C. (known to be the maximum temperature that can occur during uncontrolled regenerations). For co-firing composition, the highest temperature is the sintering temperature itself, which is usually 1400° C. or less than 1500° C. for cordierite filters. The post-firing composition for cordierite has been used for many years. Co-firing composition, on the other hand, is a relatively newer development. Since the DPF and plugs are fired together in one single step, there is potentially a tremendous economic benefit. However, co-firing compositions also have some limitations in terms of material selection (e.g., selection of materials or compositions compatible with the substrates/matrices).

While the economics are overwhelmingly in favor of using a single fire process over a dual fire process, plugging a green part presents several challenges during manufacturing. The biggest drawbacks of co-fired cement compositions include the cracking of green substrates upon drying as well as dimpling due to the inappropriate rheology of the composition, and firing cracks due to the properties mismatch between the composition and substrates (such as shrinkage and coefficient of thermal expansion (CTE)), and cracking during application (controlled and uncontrolled regenerations). In particular, cement compositions are usually developed to be close to the composition of the ceramic substrate to be plugged. However, because forming methods are different for substrate and plug paste, the properties or features are often different, such as shrinkage behavior during firing and CTE after firing. The cement composition usually exhibits higher CTE than cordierite body due to lack of orientation. To overcome the difference in shrinkage to reduce cracking upon firing, the cement composition is expected to have similar or less shrinkage during the whole course of firing. To ensure the durability of the plugging region, an excellent matching is necessary.

Accordingly, there is a need in the art for improved cement compositions for forming ceramic wall flow filters. In particular, there is a need for cement compositions and methods to make compatible cement composition for DPF substrates that can compensate for the properties mismatch between the matrix and plug, rendering the compositions suitable for use in a single fire or co-fired plugging process.

### SUMMARY

The present invention provides improved cement compositions for forming ceramic wall flow filters. The cement compositions compensate for the mismatch between matrix and plug by lowering the elastic modulus and coefficient of thermal expansion of the resulting fired plug materials.

In one broad aspect, the present invention provides a cement composition for applying to a ceramic honeycomb body, comprising an inorganic powder batch composition; a binder; a liquid vehicle; and an elastic modulus reducing additive comprising a ceramic fiber.

In another broad aspect, the present invention provides a cement composition for applying to a ceramic honeycomb body, comprising an inorganic powder batch composition; a binder; a liquid vehicle; and an elastic modulus reducing additive comprising monohydrated alumina.

In another broad aspect, the present invention provides a cement composition for applying to a honeycomb body, comprising an inorganic powder batch composition comprising an alumina source and a silica source, an organic binder, a liquid vehicle, and an elastic modulus reducing additive comprising a ceramic fiber or monohydrated alumina. In additional broad aspects, the inorganic powder batch compositions can comprise an alumina source and a silica source, an alumina source, a silica source and a magnesium oxide source, an alumina source, a silica source, and a titania source, or any combination of these.

In another broad aspect, the present invention provides a method for manufacturing a porous ceramic wall flow filter. The method according to this aspect comprises providing a honeycomb structure, where the honeycomb structure may be a green honeycomb structure, defining a plurality of cell channels bounded by porous channel walls that extend longitudinally from a first end to second end where at least one of the channels is plugged with a cement composition comprising an inorganic powder batch composition; a binder; a liquid vehicle; and an elastic modulus reducing additive selected from a ceramic fiber or a monohydrated alumina. After plugging, the plugged honeycomb structure is fired under conditions effective to form a sintered phase plugged honeycomb structure with at least one plugged channel.

In still another broad aspect, the present invention provides the porous ceramic wall flow filters manufactured from the processes and cement compositions described herein.

Additional embodiments of the invention will be set forth, in part, in the detailed description, and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

The accompanying drawings, which are incorporated in and constitute a part of this specification, illustrate certain embodiments of the instant invention and together with the description, serve to explain, without limitation, the principles of the invention.

FIG. 1 is an isometric view of a porous honeycomb filter according to embodiments of the invention.

FIG. 2 is a scanning electron microscope (SEM) image of the cement composition of inventive example C5.

FIG. 3 illustrates room temperature elastic modulus data for both inventive and comparative cement compositions.

FIGS. 4A and 4B are SEM images of polished cross-sections and top views of exemplary fired plugs according to one embodiment of the present invention.

### DETAILED DESCRIPTION

The present invention can be understood more readily by reference to the following detailed description, drawings, examples, and claims, and their previous and following description. However, before the present compositions, articles, devices, and methods are disclosed and described, it is to be understood that this invention is not limited to the specific compositions, articles, devices, and methods disclosed unless otherwise specified, as such can, of course, vary. It is also to be understood that the terminology used herein is for the purpose of describing particular embodiments only and is not intended to be limiting.

The following description of the invention is provided as an enabling teaching of the invention in its currently known embodiments. To this end, those skilled in the relevant art will recognize and appreciate that many changes can be made to the various embodiments of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

Disclosed are materials, compounds, compositions, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. Thus, if a class of substituents A, B, and C are disclosed as well as a class of substituents D, E, and F and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all embodiments of this disclosure including, but not limited to any components of the compositions and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

In this specification and in the claims which follow, reference will be made to a number of terms which shall be defined to have the following meanings:

As used herein, the singular forms “a,” “an” and “the” include plural referents unless the context clearly dictates otherwise. Thus, for example, reference to a “component” includes embodiments having two or more such components, unless the context clearly indicates otherwise.

“Optional” or “optionally” means that the subsequently described event or circumstance can or cannot occur, and that the description includes instances where the event or circumstance occurs and instances where it does not. For example, the phrase “optional component” means that the component can or can not be present and that the description includes both embodiments of the invention including and excluding the component.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As used herein, a “wt. %” or “weight percent” or “percent by weight” of a component, unless specifically stated to the contrary, refers to the ratio of the weight of the component to the total weight of the composition in which the component is included, expressed as a percentage.

As used herein, a “superaddition” or “super addition” refers to a weight percent of a component, such as for example, an organic binder, liquid vehicle, or pore former, based upon and relative to 100 weight percent of the ceramic forming inorganic powder batch component.

As briefly summarized above, in a first broad aspect the present invention provides cement compositions or plugging compositions for applying to a honeycomb body. The honeycomb body can be a ceramic honeycomb body or a green honeycomb body. The plugging or cement compositions are generally comprised of a ceramic forming inorganic powder batch composition; a binder component; a liquid vehicle component; and an elastic modulus (Young's modulus E) reducing additive. Note that cement compositions are used interchangeably throughout this disclosure. The cement compositions are suitable for use in forming ceramic wall flow filters. Among several advantages over existing cement compositions, the cement compositions of the present invention are capable of compensating for processing difficulties that can result from a mismatch in properties exhibited by the ceramic honeycomb matrix to be plugged and existing cement compositions. In particular, according to embodiments of the invention, the cement compositions exhibit lower levels of elastic modulus (E-Mod, also referred to herein as Young's Modulus). For example, as observed in the examples discussed below, relative E-mod reductions in the range of from about 20% to 80% have been observed by embodiments of the present invention. Additionally, embodiments of the invention can also exhibit relative coefficients of thermal expansion (CTE) that better match the relatively low CTE of the base honeycomb matrix.

As used herein, an elastic modulus reducing additive refers to a component of the cement composition that is capable of lowering the elastic modulus of the cement composition relative to the elastic modulus of a comparative cement composition that does not have the elastic modulus reducing additive. According to one embodiment, the modulus reducing additive can comprise a ceramic fiber. In another embodiment, the modulus reducing additive can comprise a monohydrated alumina. In still another embodiment, the modulus reducing additive can comprise a combination of a ceramic fiber and a monohydrated alumina.

As noted above, a ceramic fiber is a component that can be used to reduce the elastic modulus and increase toughness of a resulting fired cement composition. Suitable ceramic fibers for use as an elastic modulus reducing additive can include high temperature fibers made from relatively high purity alumina, zirconia, or silica. In an exemplary embodiment, the elastic modulus reducing additive can be mullite fiber. Mullite fiber remains stable and can withstand continuous operating temperatures of up to 1650° C. (3000° F.). Accordingly, in Mullite fiber, having the stoichiometric composition 3 Al₂O₃, 2 SiO₂, is especially well suited for use in connection with cordierite ceramic compositions, which are generally fired at temperatures between 1400° C. and 1430° C. When used in the cement compositions, the mullite fiber is preferably incorporated as a super addition relative to the total weight of the inorganic powder batch composition. In exemplary embodiments, the amount of mullite is preferably a superaddition amount less than or equal to about 5 weight %. For example, the mullite fiber can be used in an amount in the range of from 1 to 5 weight %, or more preferably in the range of from 1 to 3 weight %. In embodiments of the present invention, it is also preferred to disperse the ceramic fibers in a liquid vehicle prior to adding the fibers to the inorganic batch components. The fibers can be dispersed by methods including, shear mixing, stirring, vibrating, or ball milling. In one embodiment, it is especially preferred to use ball milling to disperse the ceramic fiber into a liquid vehicle.

According to other embodiments of the invention, and as noted above, monohydrated alumina (AlOOH), also referred to as boehmite, can also be used as an additive to reduce the elastic modulus of the resulting ceramic plug composition. In addition, the use of monohydrated alumina can significantly lower the CTE of the resulting fired plug or cement composition. By reducing the CTE of the resulting ceramed cement material, any potential CTE mismatch between the honeycomb substrate and the cement material can be minimized. Therefore, according to embodiments of the invention, the resulting CTE of a fired cement composition can be optimized by adjusting the desired amount of boehmite present within the cement composition. An exemplary commercially available monohydrated alumina that can be used as an elastic modulus reducing additive according to embodiments of the present invention is the Dispal 18N4-80, available from Sasol North America.

Further, by reducing the elastic modulus and by reducing the CTE of the resulting fired cement compositions, it is also possible to improve the thermal shock parameter (TSP) of the resulting plugged honeycomb body. TSP is an indicator of the maximum temperature difference a body can withstand without fracturing when the coolest region of the body is at about 500° C. Thus, for example, a calculated TSP of about 450° C. implies that the maximum temperature at some position within the honeycomb body must not exceed 950° C. when the coolest temperature at some other location within the body is 500° C. Accordingly, the thermal shock parameter or TSP=MOR_{25° C.}/{E_{25° C.}}{CTE_{H}}+C wherein MOR_{25° C.} is the modulus of rupture strength at 25° C., E_{25° C.} is the Young's elastic modulus at 25° C., C is a constant, such as 500° C., and CTE_{H} is a high temperature thermal expansion coefficient measured across the temperature range of 500° C. to 900° C.

When the monohydrated alumina is present in the cement composition, it can be incorporated as a super addition relative the inorganic powder batch composition or, alternatively, can be incorporated as a component of the inorganic powder batch composition. To that end, when present as an inorganic powder batch component, the amount of monohydrated alumina is preferably less than or equal to about 5 weight % of the batch composition. For example, the monohydrate alumina can be present in an amount in the range of from 1% to 5%, or more preferably in the range of from 1 to 3 weight %.

The elastic modulus and CTE reducing additives described above can be used in combination with a variety of ceramic forming inorganic powder batch compositions. These ceramic forming inorganic powder batch compositions can be comprised of any desired combination of inorganic batch components sufficient to form the desired sintered phase ceramic plug composition, including for example a predominant sintered phase composition comprised of ceramic, glass-ceramic, glass, and combinations thereof. It should be understood that, as used herein, combinations of glass, ceramic, and/or glass-ceramic compositions includes both physical and/or chemical combinations, e.g., mixtures or composites. Exemplary and non-limiting inorganic powder materials suitable for use in these inorganic ceramic powder batch mixtures can include cordierite, aluminum titanate, mullite, clay, kaolin, magnesium oxide sources, talc, zircon, zirconia, spinel, alumina forming sources, including aluminas and their precursors, silica forming sources, including silicas and their precursors, silicates, aluminates, lithium aluminosilicates, alumina silica, feldspar, titania, fused silica, nitrides, carbides, borides, e.g., silicon carbide, silicon nitride or mixtures of these.

For example, in one embodiment, the cement composition of the present invention can comprise an aluminum titanate based ceramic forming inorganic powder batch composition mixture that can be heat treated under conditions effective to provide a sintered phase aluminum titanate based ceramic plug. In accordance with this embodiment, the inorganic powder batch composition comprises powdered raw materials, including an alumina source, a silica source, and a titania source. These inorganic powdered raw materials can for example be selected in amounts suitable to provided a sintered phase aluminum titanate ceramic composition comprising, as characterized in an oxide weight percent basis, from about 8 to about 15 percent by weight SiO₂, from about 45 to about 53 percent by weight Al₂O₃, and from about 27 to about 33 percent by weight TiO₂. An exemplary inorganic aluminum titanate precursor powder batch composition can comprise approximately 10% quartz; approximately 47% alumina; approximately 30% titania; and approximately 13% additional inorganic additives. Additional exemplary non-limiting inorganic batch component mixtures suitable for forming aluminum titanate include those disclosed in U.S. Pat. Nos. 4,483,944; 4,855,265; 5,290,739; 6,620,751; 6,942,713; 6,849,181; U.S. Patent Application Publication Nos. 2004/0020846; 2004/0092381; and in PCT Application Publication Nos. WO 2006/015240; WO 2005/046840; and WO 2004/011386.

In an alternative embodiment, the cement composition of the present invention can comprise a cordierite based ceramic forming inorganic powder batch composition mixture that can be heat treated under conditions effective to provide a sintered phase cordierite based ceramic composition or plug. According to this embodiment, the ceramic forming inorganic powder batch composition can be a cordierite forming inorganic powder batch composition, comprising a magnesium oxide source; an alumina source; and a silica source. For example, and without limitation, the inorganic ceramic powder batch composition can be selected to provide a ceramic article which comprises at least about 93% by weight cordierite, the cordierite consisting essentially of from about 49 to about 53 percent by weight SiO₂, from about 33 to about 38 percent by weight Al₂O₃, and from about 12 to about 16 percent by weight MgO. To this end, and exemplary inorganic cordierite precursor powder batch composition can comprise about 33 to about 41 weight percent aluminum oxide source, about 46 to about 53 weight percent of a silica source, and about 11 to about 17 weight percent of a magnesium oxide source. Some additional exemplary ceramic batch material compositions for forming cordierite include those disclosed in U.S. Pat. No. 3,885,977.

It should be understood that the inorganic ceramic powder batch materials suitable for use in forming the cement compositions of the present invention can be synthetically produced materials such as oxides, hydroxides, and the like. Alternatively, they can be naturally occurring minerals such as clays, talcs, or any combination of these. Still further, the powder batch compositions can comprise any desired mixture of both synthetic and naturally occurring materials. Thus, it should be understood that the present invention is not limited to the types of powders or raw materials, as such can be selected depending on the properties desired in the final ceramic body. Further, the inorganic ceramic powder materials are generally fine powder (in contrast to coarse grained materials) some components of which can either impart plasticity, such as clays, when mixed with a liquid vehicle such as water, or which when combined with organic materials such as methyl cellulose or polyvinyl alcohol can contribute to plasticity. In embodiments, the inorganic powder batch composition can be a mixture of an alumina source, a silica source, a titania source and a magnesium oxide source, or a mixture of an alumina source, a silica source, and a magnesium oxide source.

As used herein, an alumina source is a powder, which when heated to a sufficiently high temperature in the absence of other raw materials, yields substantially pure aluminum oxide. Exemplary and non-limiting examples of alumina forming sources include corundum or alpha-alumina, gamma-alumina, transitional aluminas, aluminum hydroxide such as gibbsite and bayerite, boehmite, diaspore, aluminum isopropoxide and the like. Commercially available alumina sources can include relatively coarse aluminas, such as the Alcan C-700 series, having a particle size of about 4-6 micrometers, and a surface area of about 0.5-1 m²/g, e.g., C-701™ and relatively fine aluminas having a particle size of about 0.5-2 micrometers, and a surface area of about 8-11 m²/g, such as A-16SG available from Alcoa.

If desired, the alumina source can comprise a dispersible alumina forming source. As used herein, a dispersible alumina forming source is an alumina forming source that is at least substantially dispersible in a solvent or liquid medium and that can be used to provide a colloidal suspension in a solvent or liquid medium. In one embodiment, a dispersible alumina source can be a relatively high surface area alumina source having a specific surface area of at least 20 m²/g. Alternatively, a dispersible alumina source can have a specific surface area of at least 50 m²/g. In an exemplary embodiment, a suitable dispersible alumina source for use in the methods of the instant invention comprises monohydrated aluminum oxide (AlOOH) commonly referred to as boehmite, pseudoboehmite, and as aluminum monohydrate. In another exemplary embodiment, the dispersible alumina source can comprise the so-called transition or activated aluminas (i.e., aluminum oxyhydroxide and chi, eta, rho, iota, kappa, gamma, delta, and theta alumina) which can contain various amounts of chemically bound water or hydroxyl functionalities. Specific examples of commercially available dispersible alumina sources that can be used in the present invention include, without limitation, Dispal Boehmite, commercially available from Sasol North America and Alpha Alumina A1000, commercially available from Almatis, Inc.

Suitable silica sources can in one embodiment comprise clay or mixtures, such as for example, raw kaolin, calcined kaolin, and/or mixtures thereof. Exemplary and non-limiting clays include non-delaminated kaolinite raw clay, having average particle size of about 1-7 micrometers, and a surface area of about 5-20 m²/g, such as Hydrite MP™, those having a particle size of about 2-5 micrometers, and a surface area of about 10-14 m²/g, such as Hydrite PX™ and K-10 Raw clay, delaminated kaolinite having average particle size of about 1-5 micrometers, and a surface area of about 13-20 m²/g, , calcined clay, having a particle size of about 1-5 micrometers, and a surface area of about 6-10 m²/g. All of the above named materials are commercially available from IMERYS Minerals Ltd.

In a further embodiment, it should also be understood that the silica forming source can further comprise crystalline silica such as quartz or cristobalite, non-crystalline silica such as fused silica or silica sol, silicone resin, zeolite, and diatomaceous silica. To this end, a commercially available quartz silica forming source includes, without limitation, Imsil A25 Silica, Silverbon 200, or Cerasil 300, all available from Unimin Corporation. In still another embodiment, the silica forming source can comprise a compound that forms free silica when heated, such as for example, silicic acid or a silicon organo-metallic compound.

The titania source is preferably selected from, but not limited to, the group consisting of rutile and anatase titania. In one embodiment, optimization of the median particle size of the titania source can be used to avoid entrapment of unreacted oxide by the rapidly growing nuclei in the sintered ceramic structure. Accordingly, in one embodiment, it is preferred for the median particle size of the titania to be up to 20 micrometers.

Exemplary and non-limiting magnesium oxide sources can include talc. In a further embodiment, suitable talcs can comprise talc having a mean particle size of at least about 5 μm, at least about 8 μm, at least about 12 μm, or even at least about 15 μm. Particle size is measured by a particle size distribution (PSD) technique, preferably by a Sedigraph by Micrometrics. Talc having particle sizes of between 15 and 25 μm are preferred. In still a further embodiment, the talc can be a platy talc. As used herein, a platy talc refers to talc that exhibits a platelet particle morphology, i.e., particles having two long dimensions and one short dimension, or, for example, a length and width of the platelet that is much larger than its thickness. In one embodiment, the talc possesses a morphology index (MI) of greater than about 0.50, 0.60, 0.70, or 0.80. To this end, the morphology index, as disclosed in U.S. Pat. No. 5,141,686, is a measure of the degree of platiness of the talc. One typical procedure for measuring the morphology index is to place the sample in a holder so that the orientation of the platy talc is maximized within the plane of the sample holder. The x-ray diffraction (XRD) pattern can then be determined for the oriented talc. The morphology index semi-quantitatively relates the platy character of the talc to its XRD peak intensities using the following equation:

$$M = \frac{{I}_{x}}{{I}_{x} + 2 {I}_{y}}$$

where Iₓ is the intensity of the peak and I_{y} is that of the reflection. To that end, an exemplary commercially available magnesium oxide source suitable for use in the present invention includes, without limitation, F-Cor (100 mesh) talc, available from Luzenac, Inc. of Oakville, Ontario, Canada.

The inorganic ceramic powder batch composition comprising the aforementioned ceramic forming raw materials can be mixed together with the elastic modulus reducing additive as described above, a binder component, and a liquid vehicle, in order to provide the cement composition of the present invention.

The preferred liquid vehicle for providing a flowable or paste-like consistency to the cement composition is water, although other liquid vehicles exhibiting solvent action with respect to suitable temporary binders can be used. To this end, the amount of the liquid vehicle component can vary in order to impart optimum handling properties and compatibility with the other components in the ceramic batch mixture. The liquid vehicle content is usually present as a super addition to the total inorganic raw materials in a batch, and in an amount in the range of from 15% to 60% by weight of the total inorganic raw materials, and more preferably in the range of from 20 wt % to 50 wt %. However, it should also be understood that in another embodiment, it is desirable to utilize as little liquid vehicle component as possible while still obtaining a paste like consistency capable of being forced into selected ends of a honeycomb substrate. Minimization of liquid components in the cement composition can also lead to further reductions in the drying shrinkage of the cement compositions during the drying process.

The binder component can include temporary organic binders, inorganic binders, or a combination of both. Suitable organic binders include water soluble cellulose ether binders such as methylcellulose, hydroxypropyl methylcellulose, methylcellulose derivatives, and/or any combinations thereof. Particularly preferred examples include methylcellulose and hydroxypropyl methylcellulose. An example of a suitable commercially available methylcellulose binder is the F240 Methocel, available from Dow Chemical Company of Midland Mich. Preferably, the organic binder can be present in the composition as a super addition in an amount in the range of from 0.1 weight percent to 5.0 weight percent of the inorganic powder batch composition, and more preferably, in an amount in the range of from 0.5 weight percent to 2.0 weight percent of the inorganic powder batch composition. To this end, the incorporation of the organic binder into the batch composition can further contribute to the cohesion and plasticity of the composition. The improved cohesion and plasticity can, for example, improve the ability to shape the mixture and plug selected ends of a honeycomb body. Exemplary inorganic binders that can be used include colloidal silica and colloidal alumina.

The cement compositions can optionally comprise at least one additional processing aid and or additive such as a plasticizer, lubricant, surfactant, sintering aid, or pore former. An exemplary plasticizer for use in preparing the cement composition is glycerine. An exemplary lubricant can be a hydrocarbon oil or tall oil. A pore former may also be optionally used to optimize the porosity and median pore size of the resulting plug material. Exemplary and non-limiting pore formers can include graphite, potato starch, polyethylene beads, and/or flour.

The addition of the optional sintering aid can enhance the strength of the ceramic plug structure after firing. Suitable sintering aids can generally include an oxide source of one or more metals such as strontium, barium, iron, magnesium, zinc, calcium, aluminum, lanthanum, yttrium, titanium, bismuth, or tungsten. In one embodiment, it is preferred that the sintering aid comprise a mixture of a strontium oxide source, a calcium oxide source and an iron oxide source. In another embodiment, it is preferred that the sintering aid comprise at least one rare earth metal. Still further, it should be understood that the sintering aid can be added to the cement composition in a powder and/or a liquid form.

Still further, cement compositions of the present invention can optionally comprise one or more pre-reacted inorganic refractory fillers having expansion coefficients reasonably well matched to those of common wall flow filter materials in which the plugging material can be used. Exemplary pre-reacted inorganic refractory fillers can include powders of silicon carbide, silicon nitride, cordierite, aluminum titanate, calcium aluminate, beta-eucryptite, and beta-spodumene, as well as refractory aluminosilicate fibers formed, for example, by the processing of aluminosilicate clay. The optional pre-reacted inorganic refractory fillers can be utilized in the cement composition to optimize or control the shrinkage and/or rheology of the plugging paste or cement paste during firing process.

As further summarized above, the cement compositions of the present invention can be used to provide end plugged porous ceramic wall flow filters. In particular, these cement compositions are well suited for providing end plugged ceramic honeycomb bodies. For example, in one embodiment, an end plugged ceramic wall flow filter can be formed from a honeycomb substrate that defines a plurality of cell channels bounded by porous channel walls that extend longitudinally from an upstream inlet end to a downstream outlet end. A first portion of the plurality of cell channels can comprise an end plug, formed from a cement composition as described herein, and sealed to the respective channel walls at the downstream outlet end to form inlet cell channels. A second portion of the plurality of cell channels can also comprise an end plug, formed from a cement composition as described herein, and sealed to the respective channel walls at the upstream inlet end to form outlet cell channels.

Accordingly, the present invention further provides a method for manufacturing a porous ceramic wall flow filter having a ceramic honeycomb structure and a plurality of channels bounded by porous ceramic walls, with selected channels each incorporating a plug sealed to the channel wall. The method generally comprises the steps of providing a honeycomb structure defining a plurality of cell channels bounded by porous channel walls that extend longitudinally from an upstream inlet end to a downstream outlet end and selectively plugging an end of at least one predetermined channel with a cement composition as described herein. The selectively plugged honeycomb structure can then be fired under conditions effective to form a sintered phase ceramic plug in the at least one selectively plugged channel.

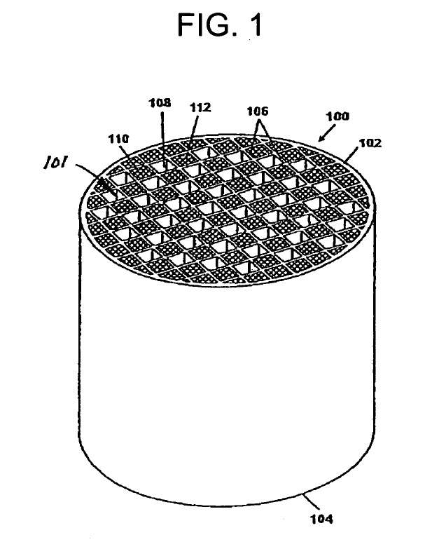

With reference to FIG. 1, an exemplary end plugged wall flow filter 100 is shown. As illustrated, the wall flow filter 100 preferably has an upstream inlet end 102 and a downstream outlet end 104, and a multiplicity of cells 108 (inlet), 110 (outlet) extending longitudinally from the inlet end to the outlet end. The multiplicity of cells is formed from intersecting porous cell walls 106. A first portion of the plurality of cell channels are plugged with end plugs 112 at the downstream outlet end (not shown) to form inlet cell channels and a second portion of the plurality of cell channels are plugged at the upstream inlet end with end plugs 112 to form outlet cell channels. The exemplified plugging configuration forms alternating inlet and outlet channels such that a fluid stream 100 flowing into the reactor through the open cells at the inlet end 102, then through the porous cell walls 106, and out of the reactor through the open cells at the outlet end 104. The exemplified end plugged cell configuration can be referred to herein as a “wall flow” configuration since the flow paths resulting from alternate channel plugging direct a fluid stream being treated to flow through the porous ceramic cell walls prior to exiting the filter.

The honeycomb substrate can be formed from any conventional material suitable for forming a porous ceramic honeycomb body. For example, in one embodiment, the substrate can be formed from ceramic forming composition that can include those conventionally known for forming cordierite, aluminum titanate, silica carbide, zirconia, magnesium oxide, stabilized zirconia, zirconia stabilized alumina, yttrium stabilized zirconia, calcium stabilized zirconia, alumina, magnesium stabilized alumina, calcium stabilized alumina, titania, silica, magnesia, niobia, ceria, vanadia, nitride, carbide, or any combination thereof.

The honeycomb substrate can be formed according to any conventional process suitable for forming honeycomb monolith bodies. For example, in one embodiment a plasticized ceramic forming batch can be shaped into a green body by any known conventional ceramic forming process, such as, e.g., extrusion, injection molding, slip casting, centrifugal casting, pressure casting, dry pressing, and the like. Typically, a ceramic precursor batch composition comprises inorganic ceramic forming batch component(s) capable of forming, for example, one or more of the sintered phase ceramic compositions set forth above, a liquid vehicle, a binder, and one or more optional processing aids and additives including, for example, lubricants, and/or a pore former. In an exemplary embodiment, extrusion can be done using a hydraulic ram extrusion press, or a two stage de-airing single auger extruder, or a twin screw mixer with a die assembly attached to the discharge end. In the latter, the proper screw elements are chosen according to material and other process conditions in order to build up sufficient pressure to force the batch material through the die.

The formed monolithic honeycomb can have any desired cell density. For example, the exemplary monolith 100 may have a cellular density from about 70 cells/in² (10.9 cells/cm²) to about 400 cells/in² (62 cells/cm²). Still further, as described above, a portion of the cells 110 at the inlet end 102 are plugged with a paste having the same or similar composition to that of the body 100. The plugging is preferably performed only at the ends of the cells and form plugs 112 typically having a depth of about 5 to 20 mm, although this can vary. A portion of the cells on the outlet end 104 but not corresponding to those on the inlet end 102 may also be plugged in a similar pattern. Therefore, each cell is preferably plugged only at one end. The preferred arrangement is to therefore have every other cell on a given face plugged as in a checkered pattern as shown in FIG. 1. Further, the inlet and outlet channels can be any desired shape. However, in the exemplified embodiment shown in FIG. 1, the cell channels are typically square shaped.

It should be understood that one of ordinary skill in the art will be able to determine and optimize a desired ceramic forming batch composition suitable for forming a particularly desired ceramic honeycomb substrate without requiring any undue experimentation. For example, the inorganic batch components can be selected so as to yield a ceramic honeycomb article comprising cordierite, mullite, spinel, aluminum titanate, or a mixture thereof upon firing. For example, and without limitation, in one embodiment, the inorganic batch components can be selected to provide a cordierite composition consisting essentially of, as characterized in an oxide weight percent basis, from about 49 to about 53 percent by weight SiO₂, from about 33 to about 38 percent by weight Al₂O₃, and from about 12 to about 16 percent by weight MgO. To this end, an exemplary inorganic cordierite precursor powder batch composition preferably comprises about 33 to about 41 weight percent aluminum oxide source, about 46 to about 53 weight percent of a silica source, and about 11 to about 17 weight percent of a magnesium oxide source. Exemplary non-limiting inorganic batch component mixtures suitable for forming cordierite include those disclosed in U.S. Pat. Nos. 3,885,977; RE 38,888; 6,368,992; 6,319,870; 6,24,437; 6,210,626; 5,183,608; 5,258,150; 6,432,856; 6,773,657; 6,864,198; and U.S. Patent Application Publication Nos. 2004/0029707; 2004/0261384.

Alternatively, in another embodiment, the inorganic batch components can be selected to provide, upon firing, a mullite composition consisting essentially of, as characterized in an oxide weight percent basis, from 27 to 30 percent by weight SiO₂, and from about 68 to 72 percent by weight Al₂O₃. An exemplary inorganic mullite precursor powder batch composition can comprise approximately 76% mullite refractory aggregate; approximately 9.0% fine clay; and approximately 15% alpha alumina. Additional exemplary non-limiting inorganic batch component mixtures suitable for forming mullite include those disclosed in U.S. Pat. Nos. 6,254,822 and 6,238,618.

Still further, the powdered inorganic batch components can be selected to provide, upon firing, an alumina titanate composition comprising, as characterized in an oxide weight percent basis, from about 8 to about 15 percent by weight SiO₂, from about 45 to about 53 percent by weight Al₂O₃, and from about 27 to about 33 percent by weight TiO₂. An exemplary inorganic aluminum titanate precursor powder batch composition can comprises approximately 10% silica forming source (such as quartz); approximately 47% alumina forming source (such as α-alumina); approximately 30% titania; and approximately 13% additional inorganic additives. Additional exemplary non-limiting inorganic batch component mixtures suitable for forming aluminum titanate include those disclosed in U.S. Pat. Nos. 4,483,944; 4,855,265; 5,290,739; 6,620,751; 6,942,713; 6,849,181; U.S. Patent Application Publication Nos. 2004/0020846; 2004/0092381; and in PCT Application Publication Nos. WO 2006/015240; WO 2005/046840; and WO 2004/011386.

Once the green honeycomb body is formed, the green body can then be dried to at least substantially remove any liquid vehicle present still present. As used herein, to at least substantially remove any liquid refers to the removal of at least 95%, at least 98%, at least 99%, or even at least 99.9% of the liquid vehicle present. To that end, exemplary and non-limiting drying conditions suitable for removing the liquid vehicle include heating formed green body at a temperature of at least 50° C., at least 60° C., at least 70° C., at least 80° C., at least 90° C., at least 100° C., at least 110° C., at least 120° C., at least 130° C., at least 140° C., or even at least 150° C. for a period of time sufficient to at least substantially remove the liquid vehicle from the cement composition. Exemplary drying periods can include at least about 1 hour, at least about 2 hours, or even at least about 3 hours.

After drying, a cement composition as described herein can then be forced into selected open cells of the dried green honeycomb substrate in the desired plugging pattern and to the desired depth, by one of several conventionally known plugging process methods. For example, selected channels can be end plugged as shown in FIG. 1 to provide a “wall flow” configuration whereby the flow paths resulting from alternate channel plugging direct a fluid or gas stream entering the upstream inlet end of the exemplified honeycomb substrate, through the porous ceramic cell walls prior to exiting the filter at the downstream outlet end.

The plugged honeycomb structure can then be dried again and subsequently fired under conditions effective to convert the green body and the plugging material into a primary sintered phase ceramic composition. Conditions effective for drying the cement composition again include those conditions capable of removing at least substantially all of the liquid vehicle present within the cement composition. Exemplary and non-limiting drying conditions suitable for removing the liquid vehicle include heating the end plugged honeycomb substrate at a temperature of at least 50° C., at least 60° C., at least 70° C., at least 80° C., at least 90° C., at least 100° C., at least 110° C., at least 120° C., at least 130° C., at least 140° C., or even at least 150° C. for a period of time sufficient to at least substantially remove the liquid vehicle from the cement composition. In one embodiment, the conditions effective to at least substantially remove the liquid vehicle comprise heating the cement composition at a temperature in the range of from 60° C. to 120° C. for a period of about 2 hours. Further, the heating can be provided by any conventionally known method, including for example, hot air drying, or RF and/or microwave drying.

After drying, the cement compositions as described herein can be fired under conditions effective to convert the cement material into a primary sintered phase ceramic composition. The effective firing conditions will depend in part on the particular composition of the cement material. However, effective firing conditions will typically comprise firing the plugging material at a maximum firing temperature in the range of from about 1350° C. to about 1500° C., and more preferably at a maximum firing temperature in the range of from 1375° C. to 1430° C. This is a post-firing embodiment (or a 2-step firing process or a second firing process).

In one embodiment, the step of firing the plugging material can be a “single fire” or “co-fired” process. According to this embodiment, the selectively end plugged honeycomb substrate is a formed green body or unfired honeycomb body comprised of a dried ceramic forming precursor composition as described above. The conditions effective to fire the cement composition are also effective to convert the dried ceramic precursor composition of the green body into a sintered phase ceramic composition. Further according to this embodiment, the unfired honeycomb green body can be selectively plugged with a cement composition having a composition that is substantially equivalent to the inorganic composition of the honeycomb green body. Thus, the plugging material can for example comprise either the same raw material sources or alternative raw material sources chosen to at least substantially match the drying and firing shrinkage of the green honeycomb.

The conditions effective to single fire the cement composition and the green body can comprise firing the selectively plugged honeycomb structure at a maximum firing temperature in the range of from 1350° C. to 1500° C., and more preferably at a maximum firing or soak temperature in the range of from 1375° C. to 1430° C. The maximum firing or soak temperature can, for example, be held for a period of time in the range of from 5 to 30 hours, including exemplary time periods of 10, 15, 20, or even 25 hours. Still further, the entire firing cycle, including the initial ramp cycle up to the soak temperature, the duration of the maximum firing or soak temperature, and the cooling period can, for example, comprise a total duration in the range of from about 100 to 150 hours, including 105, 115, 125, 135, or even 145 hours. According to embodiments of the invention, after firing is complete, the finished plugs will exhibit similar thermal, chemical, and/or mechanical properties to that of the fired honeycomb body.

### EXAMPLES

To further illustrate the principles of the present invention, the following examples are put forth so as to provide those of ordinary skill in the art with a complete disclosure and description of how the cement compositions and methods claimed herein are made and evaluated. They are intended to be purely exemplary of the invention and are not intended to limit the scope of what the inventors regard as their invention. Efforts have been made to ensure accuracy with respect to numbers (e.g., amounts, temperatures, etc.); however, some errors and deviations may have occurred. Unless indicated otherwise, parts are parts by weight, temperature is ° C. or is at ambient temperature, and pressure is at or near atmospheric.

In the following examples, 8 inventive cement compositions (E1 through E8) according to the present invention were prepared comprising varying amounts of mullite fiber, monohydrated alumina, and combinations thereof, as an elastic modulus reducing additive. These 8 compositions were compared to a corresponding comparative cement composition that was absent any of the elastic modulus reducing additives. Table 1 lists the specific raw materials used to prepare both the inventive and comparative cement compositions. The inventive cement compositions were prepared by incorporating the mullite fibers and/or the monohydrate alumina into the comparative batch composition. The relative amounts of inorganic batch components and the elastic modulus reducing agents for the comparative and inventive samples are shown in Table 2. To that end, the mullite fibers were present in the cement composition as a superaddition. The monohydrated alumina was considered a source of alumina for the calculation of cordierite stoichiometry and therefore was present as a component of the inorganic powder batch composition. A stoichiometric batch adjustment was made for each batch in which the monohydrated alumina was present.

For the compositions shown in Table 2, organic components are the same for each batch, including 0.45 wt % methylcellulose binder, 0.25 wt % of lubricant oil and 9.0 wt % of potato starch as pore former. The water content is varied from 34% to 38% as necessary to make the rheology of paste that can be pluggable into the honeycomb channels.

TABLE 1
Raw materials

| | | | | Average Particle | |
|---|---|---|---|---|---|
| | Supplier | Component | Grade | Size (μm) | Comment |
| Inorganic powder | Luzenac | Talc | F-Cor (−100mesh) | 15-25 μm | Platy talc |
| Compostion | Imerys | Kaopaque Clay | K-10 | 1-7 μm | surface area of |
| | | | | | 5-20 m²/g |
| | Huber | Hydrated Alumina | SB432 | 3-8 μm | |
| | Alcan | Alumina | C701 | 5-10 μm | |
| | Unimin | Silica | Cerasil 300 | 20-30 μm | |
| | Sasol | Beohmite | 18N4-80 | not applicable | disperable nano |
| | | | | | particles |
| super- | Unifrax | Ceramic Fiber | Mullite | 5-50 μm | |
| addition | | | | | |
| Pore | Asbury | Graphite | 4740 | 100-130 μm | platy |
| Former | Emsland-Starke | Potato Starch | Native | 40-50 μm | |
| Organic | CMC | Methocel | F240 | not applicable | |
| | | Tall Oil | | | |

TABLE 2
Experimental and Comparative Batch Compositions

| | Comparable | | | | | | | | |
|---|---|---|---|---|---|---|---|---|---|
| | Composition | E1 | E2 | E3 | E4 | E5 | E6 | E7 | E8 |
| Talc | 40.7% | 40.7% | 40.7% | 40.5% | 40.3% | 40.5% | 40.3% | 40.5% | 40.3% |
| Hydrated Clay | 16.0% | 16.0% | 16.0% | 15.9% | 15.8% | 15.9% | 15.8% | 15.9% | 15.8% |
| Hydrated | 16.0% | 16.0% | 16.0% | 15.9% | 15.8% | 15.9% | 15.8% | 15.9% | 15.8% |
| Alumina | | | | | | | | | |
| Alumina | 14.8% | 14.8% | 14.8% | 13.0% | 11.2% | 13.0% | 11.2% | 13.0% | 11.2% |
| Silica | 12.5% | 12.5% | 12.5% | 12.4% | 12.4% | 12.4% | 12.4% | 12.4% | 12.4% |
| Beohmite | 0.0% | 0.0% | 0.0% | 2.2% | 4.4% | 2.2% | 4.4% | 2.2% | 4.4% |
| Inorganic | 100% | 100% | 100% | 100% | 100% | 100% | 100% | 100% | 100% |
| Powder Total | | | | | | | | | |
| Mullite Fiber | 0.0% | 1.4% | 2.8% | 0.0% | 0.0% | 1.4% | 1.4% | 2.8% | 2.8% |

Note that batch compositions E1, E2, E3, E4, E5, E6, E7 and E8 are experimental or inventive batch compositions and the comparable composition is a comparative batch composition. Experimental or inventive batch compositions comprise, from about 35% to about 45% Talc, or from about 38% to about 42% Talc, from about 14% to about 20%, or from about 14% to about 18% Hydrated Clay; from about 14% to about 20%, or from about 14% to about 18% Hydrated Alumina; from about 10% to about 18% or from about 10% to about 16% Alumina; from about 10% to about 15%, or from about 10% to about 14% Silica, where Boehmite is present, from about 1.5% to about 6% Boehmite, or from about 1.5% to about 5% Boehmite, and, where a super addition of mullite fiber is present, from about 1% to about 5% mullite, or from about 1% to about 3.5% mullite. In embodiments, the experimental or inventive compositions of the present invention include an elastic modulus-reducing additive of mullite fibers, or monohydrated alumina (Boehmite in Table II) or a combination of mullite fibers and monohydrated alumina.

To prepare the comparative and inventive cement compositions of Table II, the dry ingredients were first batched in mixing bowl under a vent hood. Water was then added as a super addition while mixing continued for about 2 to 3 minutes until the batch composition formed a paste like consistency and began to stick to the side of the mixing bowl. Where used, the mullite fibers were first dissolved in a portion of the water that was held out as part of the total water call. The mixing bowl was then placed into a vacuum mixer, where mixing continued for another 5 to 10 minutes to remove air from the paste.

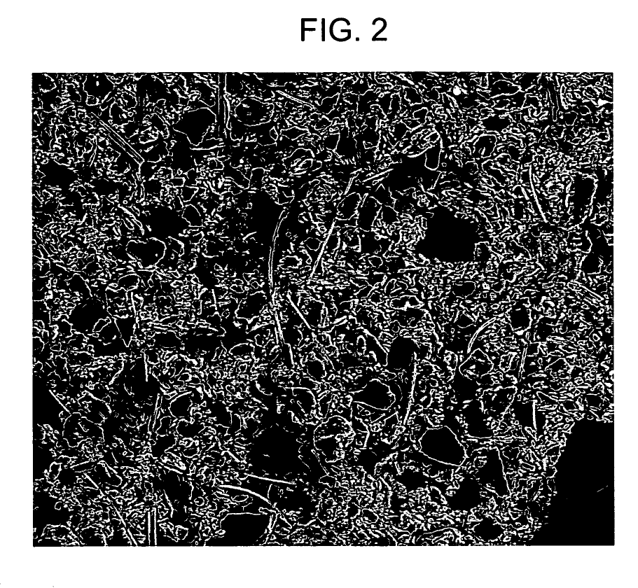

After vacuum mixing, the cement compositions were applied to cordierite green bodies, dried, and subsequently fired, to evaluate their performance as end plugs, including an evaluation of the strength of the resulting plug. Cordierite blocks to be plugged were placed upside down onto a spacer 6-8 mm high. Tape was then wrapped around the outside of the block 2-3 times. The paste was then placed within the tape and smoothed. The block was then placed between 2 hard plastic plates and put into a hand press. The press was lowered onto the block until the pressure gauge began to move being careful not to apply to much pressure as too much pressure can crush the honeycomb cells. The pressure was then released and the tap was removed. The plugged green bodies were then placed in an oven to dry over night. After drying, the plugged cordierite green bodies were then fired at a maximum firing temperature in the range of about 1400° C. to 1430° C. for a period of about 15 hours. The entire firing cycle, including the initial ramp cycle up to the soak temperature, the duration of the maximum firing or soak temperature, and the cooling period took approximately 135 hours. After firing, plug strength was measured through the plug push-in technique, indicating the amount of force required to push the formed plug in. The plug strength data is reported in Table 3 below. The reported data are the average of 9 measurements. It can be seen that even though increasing the amount of monohydrated alumina lead to an overall decrease in the overall plug strength. However, all data were still well above conventionally acceptable limits of about 0.3 lbf. Additionally, CTE bars were also cut from cast sheets formed from the cement composition. To prepare the cast sheets, a plastic plate was used with 2 flat rods placed on each side, approximately 3-4″ apart. The paste was put onto the plate and smoothed out evenly between the 2 rods. Once the plate is full and smoothed out, the rods were removed and the sheet was carefully cut in half (too avoid cracking). The entire plate was then placed into an oven to dry overnight at 90° C. FIG. 2 shows the microstructure of the exemplary green cement composition formed according to inventive composition 5, prior to firing. As can be seen, the mullite fibers are uniformly distributed in the body.

Once the cast sheets were dry, CTE bars having dimensions of 2.5″×0.25″×0.25″ were cut from the cast sheet and measured for their initial volume. The formed bars were then fired at a maximum firing temperature in the range of about 1400° C. to 1430° C. for a period of about 15 hours. The entire firing cycle, including the initial ramp cycle up to the soak temperature, the duration of the maximum firing or soak temperature, and the cooling period took approximately 135 hours. The resulting fired CTE bars were then evaluated for various properties, including a secondary phase analysis, hardness, CTE, and elastic modulus. The data from these evaluations are set forth in Table III and are discussed below.

TABLE 3
Properties of Inventive and Comparative Plugging cements

| | Comparative | | | | | | | | |
|---|---|---|---|---|---|---|---|---|---|
| | Composition | E1 | E2 | E3 | E4 | E5 | E6 | E7 | E8 |
| Secondary | | | | | | | | | |
| Phase | | | | | | | | | |
| Cordierite (%) | 98 | 97 | 96 | 98 | 98 | 97 | 96 | 96 | 96 |
| Mullite (%) | 0 | 0.6 | 2.2 | 0 | 0 | 0.6 | 1.5 | 2.1 | 2 |
| Spinel (%) | 1.9 | 2.1 | 2.2 | 1.9 | 2 | 2.1 | 2.1 | 1.9 | 2.1 |
| Properties | | | | | | | | | |
| Plug Strength | 18.43 | 19.24 | 16.11 | 13.64 | 12.06 | 10.75 | 7.87 | 7.40 | 5.56 |
| (lbf) | | | | | | | | | |
| Hardness | 4.67 | 3.56 | 2.55 | 5.61 | 6.25 | 3.07 | 3.33 | 2.61 | 3.09 |
| (Kg/mm²) | | | | | | | | | |
| CTE (25-800) | 10.4 | 9.6 | 11 | 9.7 | 8.5 | 8.8 | 8.1 | 8.7 | 8.2 |
| 10⁻⁷/° C. | | | | | | | | | |
| E-Mod at | 2.95 | 1.65 | 2.25 | 1.93 | 2.18 | 2.31 | — | 2.01 | 2.01 |
| 25° C. (10⁵ psi) | | | | | | | | | |

The X-ray phase analysis data indicates that all secondary phases of the inventive (or experimental) fired cement compositions are within the range of a standard cordierite composition. This indicates that the inventive cement compositions were close to stoichiometric. As indicated, cordierite was the primary phase with numbers over 96% for quantitative analysis. Mullite and spinel accounted for the remaining phases. The compositions containing mullite fibers tended to exhibit slightly lower cordierite percentages and higher mullite percentages than the comparative composition since mullite fibers were incorporated into the batch but did not melt completely during the firing process.

The CTE analysis indicates that the addition of the additives in the inventive cement compositions were largely effective in reducing the overall CTE of the plug material. In particular, the measured CTE of the inventive compositions was the same or lower than comparative composition. As described herein, lowering the CTE can potentially lead to an improved thermal shock behavior during end use applications.

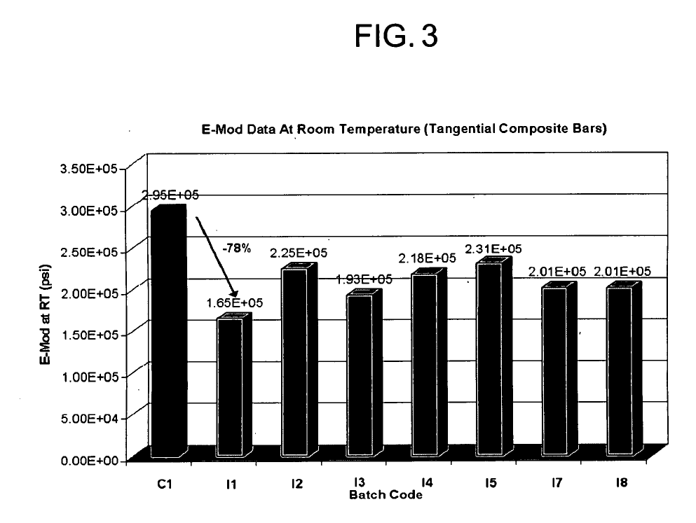

The room temperature elastic modulus data set forth in Table 3 is also plotted in FIG. 3. It can be seen that a lower E-mod has been achieved for all of the inventive compositions. As described herein, lowering the elastic modulus can potentially lead to an improved thermal shock behavior during end use applications.

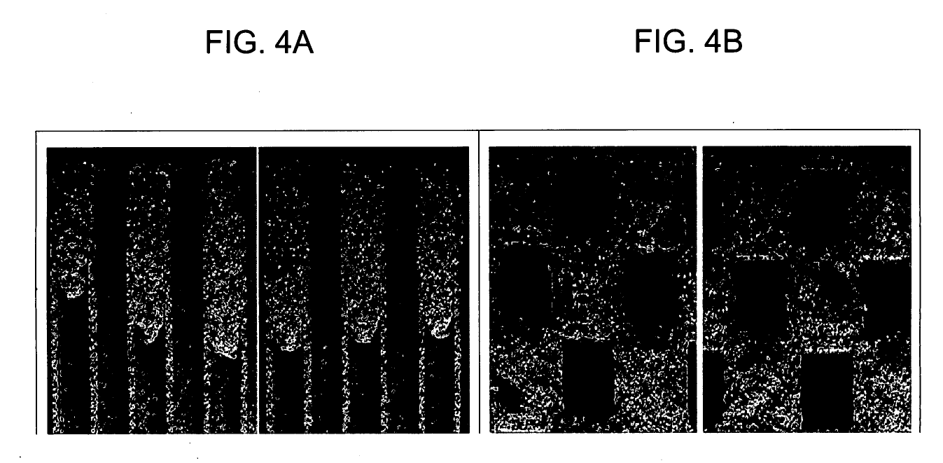

Lastly, FIGS. 4A and 4B provides an SEM polished cross-section top view image for fired plugs comprised of inventive batch composition E1. As can be seen from these images, the inventive cement composition provided for resulting fired plugs having relatively uniform depths and substantially absent of any significant voids.

Thus, embodiments of LOW EXPANSION CEMENT COMPOSITIONS FOR CERAMIC MONOLITHS are disclosed. One skilled in the art will appreciate that the compositions and methods described herein can be practiced with embodiments other than those disclosed. The disclosed embodiments are presented for purposes of illustration and not limitation.

1. A cement composition for applying to a honeycomb body, comprising:
an inorganic powder batch composition comprising an alumina source and a silica source;
an organic binder;
a liquid vehicle; and
an elastic modulus reducing additive comprising a mullite fiber.

2. The cement composition of claim 1, wherein the inorganic powder batch composition further comprises a magnesium oxide source.

3. The cement composition of claim 1, wherein the inorganic powder batch composition further comprises a titanium oxide source.

4. The cement composition of claim 1, wherein the mullite fiber is present in an amount not more than 5 weight % calculated as a super addition relative to the inorganic powder batch composition.

5. The cement composition of claim 1 wherein the honeycomb body is a green honeycomb body.

6. The cement composition of claim 1, wherein the elastic modulus reducing additive further comprises monohydrated alumina.

7. A cement composition for applying to a ceramic honeycomb body, comprising:
an inorganic powder batch composition comprising an alumina source and a silica source;
an organic binder;
a liquid vehicle; and
an elastic modulus reducing additive comprising monohydrated alumina.

8. The cement composition of claim 7, wherein the inorganic powder batch composition further comprises a magnesium oxide source.

9. The cement composition of claim 7, wherein the monohydrated alumina is present in an amount not more than 5 weight % of the total inorganic powder batch composition.

10. The cement composition of claim 7 wherein the honeycomb body is a green honeycomb body.

11. The cement composition of claim 7, wherein the elastic modulus reducing additive further comprises mullite fiber.

12. A porous ceramic wall flow filter, comprising:
a honeycomb substrate defining a plurality of cell channels bounded by porous channel walls that extend longitudinally from a first end to a second end;
wherein at least one of the plurality of cell channels comprises a plug; and
wherein the plug is formed from a cement composition comprising:
an inorganic powder batch composition comprising an alumina source and a silica source;
an organic binder;
a liquid vehicle; and
an elastic modulus reducing additive selected from a mullite fiber, a monohydrated alumina, or a combination of mullite fiber and monohydrated alumina.

13. The porous ceramic wall flow filter of claim 12, wherein the plug exhibits an elastic modulus that is lower than an elastic modulus of a comparative plug formed from a cement composition comprising:
the inorganic powder batch composition;
the organic binder; and
the liquid vehicle;
in the absence of the elastic modulus reducing additive selected from the group consisting of a mullite fiber and a monohydrated alumina.

14. A method for manufacturing a porous ceramic wall flow filter, comprising the steps of:
providing a green honeycomb structure having a plurality of cell channels bounded by porous channel walls that extend longitudinally from a first end to a second end;
plugging at least one channel with a cement composition comprising:
an inorganic powder batch composition comprising an alumina source and a silica source;
an organic binder;
a liquid vehicle; and
an elastic modulus reducing additive selected from a mullite fiber, a monohydrated alumina or a combination of mullite fiber and monohydrated alumina; and
firing the plugged green honeycomb structure under conditions effective to form a ceramic plugged honeycomb structure.

15. The method of claim 14, wherein the inorganic powder batch composition further comprises a titania source.

16. The method of claim 14, wherein the green honeycomb structure is comprised of cordierite and wherein the inorganic powder batch composition further comprises a magnesium oxide source.

17. The method of claim 14, wherein the elastic modulus reducing additive comprises monohydrated alumina.

18. The method of claim 14, wherein the cement composition further comprises a pore forming agent.

19. The method of claim 14, wherein prior to firing the plugged honeycomb structure, the cement composition is dried under conditions effective to at least substantially remove the liquid vehicle.

20. The method of claim 19, wherein the conditions effective to at least substantially remove the liquid vehicle comprise heating the cement composition at a temperature in the range of from 60° C. to 120° C.

21. The method of claim 14, wherein the conditions effective to fire the plugged honeycomb structure comprises firing the plugged honeycomb structure at a temperature in the range of from 1350° C. to 1450° C.

22. The method of claim 14, wherein the green honeycomb structure is comprised of a cordierite forming composition or an aluminum titanate forming composition.
